(19) United States
(12) Patent Application Publication
(10) Pub. No.: US 2004/0243843 A1
(43) Pub. Date: Dec. 2, 2004

(54) Content server defending system

(76) Inventors: Yuri Kadobayashi, Nara (JP); Teruhiko Takeda, Kanagawa (JP)

Correspondence Address: Norman P Soloway, Hayes Soloway, 130 W Cushing Street, Tucson, AZ, 85701, US

(21) Appl. No.: 10/489,521

(22) PCT Filed: Sep. 19, 2001
(86) PCT No.: PCT/JP01/08156

(51) Int. Cl. G06F 11/30

(52) U.S. Cl. 713/201

(57) ABSTRACT

A content server defending system for defending content servers that distribute content registered through the Internet to internet terminals, which are capable of connecting with the Internet, against false access. The system comprises auxiliary servers with which copied content data copied from at least a part of distribution content data registered with the content servers is registered, and which are capable of distributing the copied content data to the internet terminals; an access dispenser for assigning requests from the internet terminals to distribute the content to each of the servers so as to substantially equalize the distribution load on each server; a false access detector for detecting false access to each server; and a false access cutoff for cutting off the communication of false access when the false access detector detects the false access.

### TECHNICAL FIELD

The present invention relates to a content server defending system for defending content servers that distribute the content data to internet terminals, which can be connected with the Internet, against a false access.

### BACKGROUND

In recent years, with rapid spread of the Internet that is an open computer network, many companies and people actively use the Internet to provide content that they own for lot more people inexpensively and quickly, and many content sites (WEB servers) are constructed.

As the number of the content sites (WEB servers) increases, false access to the content sites (WEB servers), which is damage such as alteration of content in particular, is likely to increase, and methods of false access are also likely to advance with everyday improvement of computer processing power.

Particularly in recent years, DDoS attacks have been a mainstream, where a large number of computers distributed in a plurality of networks access a specific content site (WEB server) all at once and overflow a communication path to stop its function.

There exist two types of methods, which are a network type and a host type, as a conventional method for defending the content sites (WEB servers) against the false access including the DDoS attacks. First, network type intrusion detection is a method where reassembly process is applied to packets flowing on a network and successive approximation with known false access patterns is performed to detect the false access. Further, a host type intrusion detection operates for single computer, where it constantly monitors packets received by the computer, alarm messages from an operating system (OS), the number of system calls processed by the operating system (OS), and the like, and thus detects the false access.

However, it is necessary to analyze the content of packets in detail regarding a certain type of attack in the network type intrusion detection method, but its processing is complicated and cannot be performed in high-speed. On the contrary, the analysis of packets needs to be simplified in order to detect the false access in a high-speed network, and there exists a problem of processing load that detailed analysis cannot be performed. Furthermore, in the host type intrusion detection method, the computer (server) needs to perform processing such as monitoring of packets, message analysis, and system behavior analysis in addition to regular processing (such as information distribution and calculation), so that it is difficult to execute detection and defense of the false access in a state that the computer (server) is highly loaded by the regular processing. Such highly loaded environment is obvious particularly in the information distribution in the high-speed network.

For this reason, there has not been a practical defending system capable of defending the content sites (WEB servers) against the false access, particularly the DDoS attacks where access from a large number of computers occurs simultaneously, and such content server defending system has been long-waited.

Consequently, the present invention has been created by paying attention to the above-described problems, and its object is to provide the practical content server defending system capable of defending the content sites (WEB servers) against the false access, particularly the DDoS attacks.

### DISCLOSURE OF THE INVENTION

To solve the above-described problems, the content server defending system of the present invention is a content server defending system for defending content servers that distribute the content registered through the Internet to the internet terminals, which are capable of connecting with the Internet, against a false access, and the system comprises: auxiliary servers, with which copied content data copied from at least a part of distribution content data registered with the content servers is registered, and which are capable of distributing the copied content data to the internet terminals; access dispersing means for assigning requests from the internet terminals to distribute the content to each server so that the distribution load on each server is substantially equalized; false access detecting means for detecting false access to each server; and false access cutoff means for cutting off the communication of false access when the false access detecting means detects the false access.

According to the characteristics, since the access dispersing means disperses the content distribution requests (access) from the internet terminals such that the distribution load to each auxiliary server is substantially equalized, the false access detecting means detects the false access even in the DDoS attacks and the false access cutoff means cuts off the false access, so that the content servers can be defended from the false access.

It is preferable that the content server defending system of the present invention be provided with the false access detecting means and the false access cutoff means corresponding to each server, and the false access detecting means or the false access cutoff means of each server notify another false access detecting means or false access cutoff means of information regarding the false access based on the detection of false access by the false access detecting means.

Consequently, by notifying the false access detecting means or the false access cutoff means, which is provided corresponding to the other servers, of the information regarding the false access when the false access is detected, other false access detecting means or false access cutoff means can quickly deal with attacks by the false access, and defensive capability of the entire system is improved.

In the content server defending system of the present invention, it is preferable that the access dispersing means combine a DNS server that transforms a domain name on the Internet into an IP address of each server on the Internet.

Accordingly, since the DNS server constantly monitors access, it is possible to preferably build the access dispersing means by making the DNS server have an access dispersing function.

In the content server defending system of the present invention, it is preferable that domain names, which are released to the public and different from those of the content servers, be given to the auxiliary servers, and the IP addresses of the content servers be not released to the public.

Accordingly, it is possible to keep the IP addresses of the content servers secret, and the attacks to the content servers can be avoided as much as possible.

### BRIEF DESCRIPTION OF THE DRAWINGS

FIG. 1 is a block diagram showing the constitution of a content distribution system in an embodiment of the present invention.

FIG. 2 is a view showing a processing state in a layer 4 (L4) switch used in the content distribution system in the embodiment of the present invention.

FIG. 3 is a flowchart showing the processing content of the DNS server used in the content distribution system in the embodiment of the present invention.

FIG. 4 is a flowchart showing the processing content in false access detection systems (IDS) used in the content distribution system in the embodiment of the present invention.

FIG. 5 is a flowchart showing the content of update processing of a false access pattern file in the false access detection systems (IDS) used in the content distribution system in the embodiment of the present invention.

FIG. 6 is a view showing the processing content in an access analysis system used in the content distribution system in the embodiment of the present invention.

FIG. 7 is an exemplary view showing communication of information among equipment of each site used in the content distribution system in the embodiment of the present invention.

### BEST MODE FOR CARRYING OUT THE INVENTION

The embodiments of the present invention will be described as follows based on the drawings.

### Embodiments

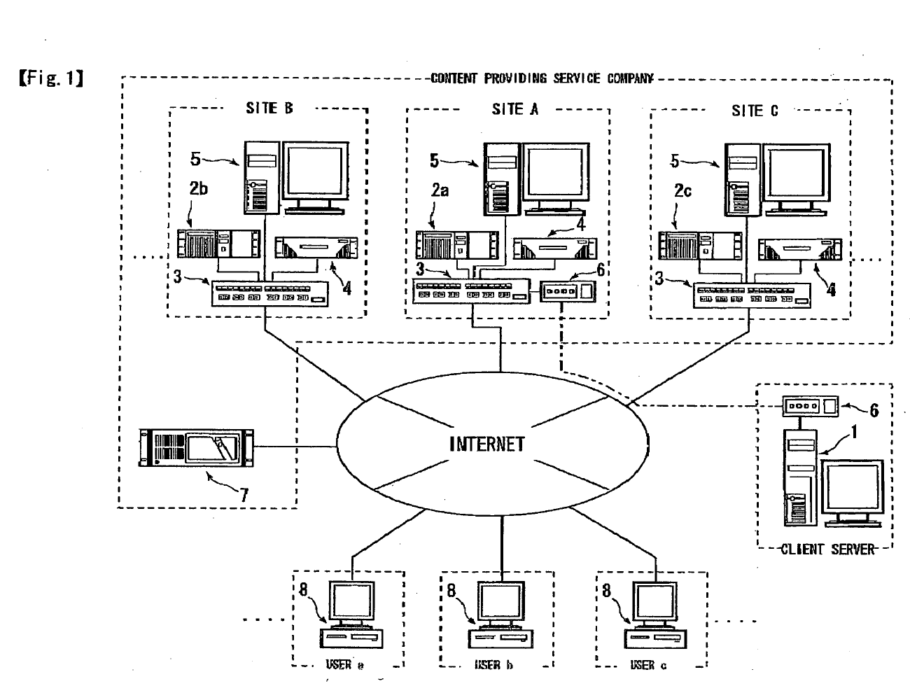

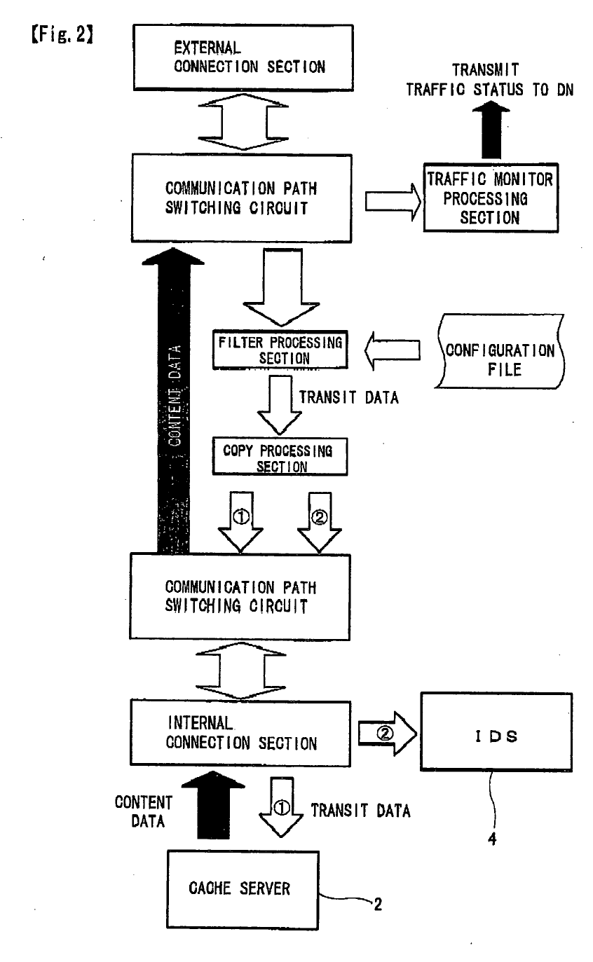

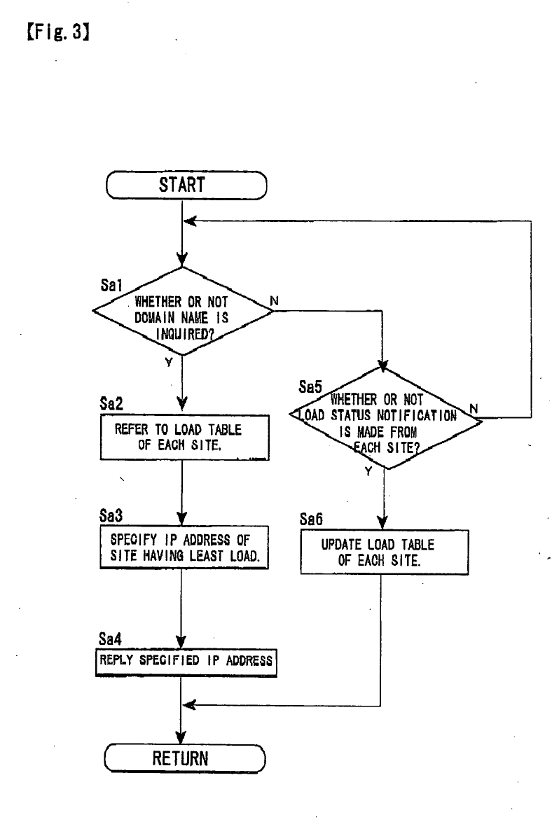

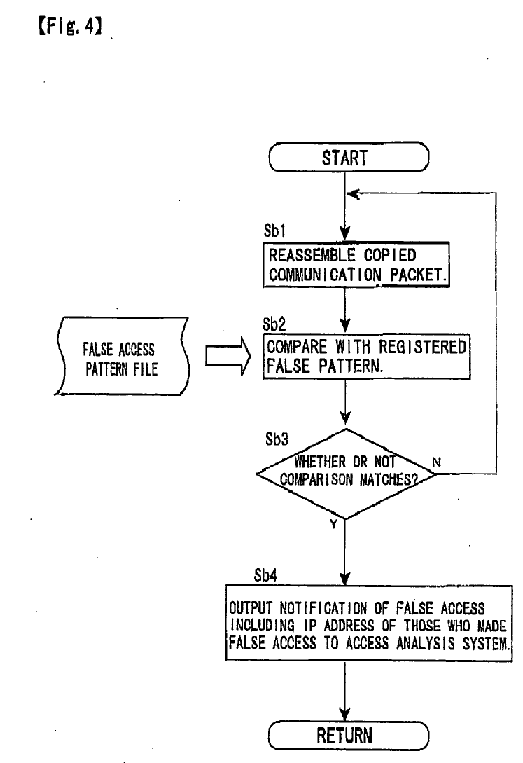

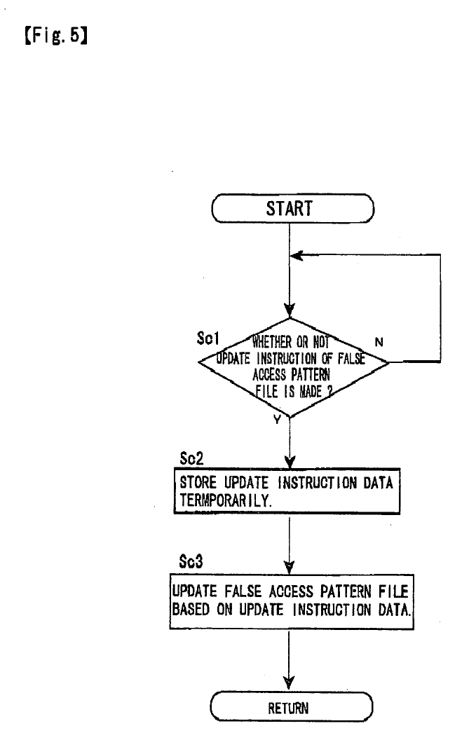

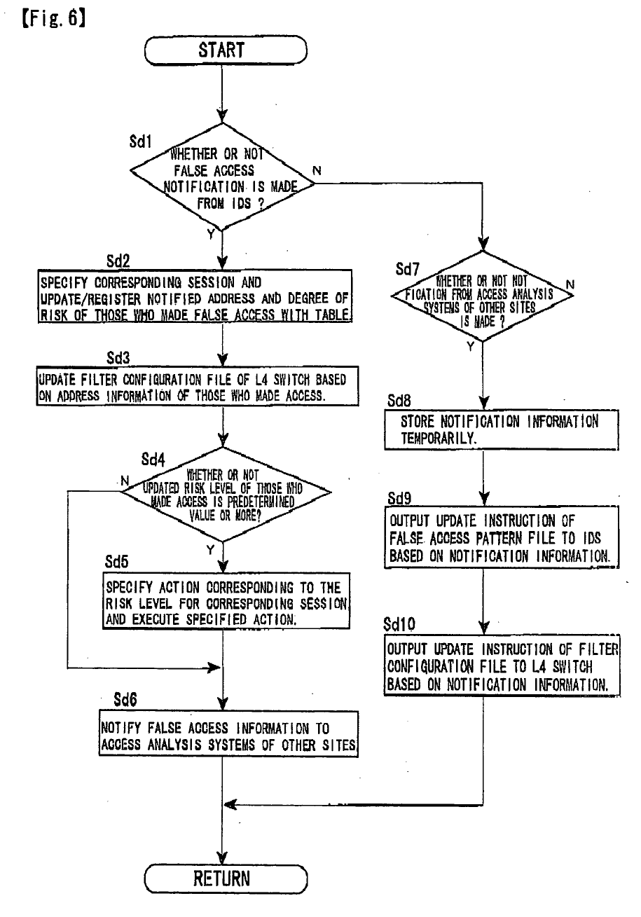

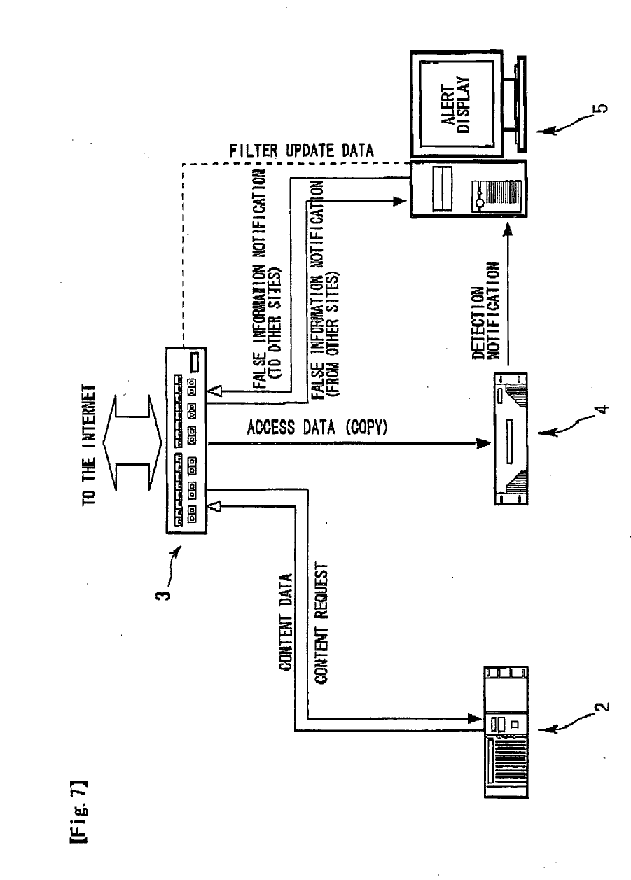

FIG. 1 is the block diagram showing the constitution of the content distribution system to which the content server defending system of the present invention is applied, FIG. 2 is the view showing the processing state in the layer 4 (L4) switch used in the content distribution system in this embodiment, FIG. 3 is the flowchart showing the processing content of the DNS servers that are the access dispersing means used in the content distribution system of this embodiment, FIG. 4 is the flowchart showing the processing content in the false access detection systems (IDS) that are the false access detecting means used in the content distribution system of this embodiment, FIG. 5 is the flowchart showing the content of update processing of the false access pattern file in the false access detection systems (IDS), FIG. 6 is the view showing the processing content in the access analysis system that is the false access cutoff means used in the content distribution system of this embodiment, and FIG. 7 is the exemplary view showing the communication of information among equipment of each site used in the content distribution system of this embodiment.

Note that this embodiment shows an example of the content distribution system by a content providing service company, which defends a client server 1, which is a provider of content, from false access, and distributes the content data provided by the clients on behalf of them, but the present invention is not limited to this and its usage modes are optional.

First, the content distribution system of this embodiment is in the constitution as shown in FIG. 1, and the content providing service company has sites A, B, C . . . where content servers 2a, 2b, 2c . . . are installed, with which the content data provided by the clients are registered such that the content data is distributable based on the distribution requests from internet terminals 8 of end users, which are connected with the Internet. In these sites, site A is connected with the client server 1 via a VPN system 6 (described later) and the Internet, where the content data registered with the client server 1 is temporarily registered with the main server 2a installed in site A, and then, the content data is distributed to and registered with the cache servers 2b, 2c . . . that are the auxiliary servers installed in another site B, C . . . .

Each site is provided with equipment such as: the content server 2a, 2b, 2c . . . ; a layer 4 (L4) switch 3, which is connected with the Internet via a communication device (not shown) and connected with each of the equipment including the content server 2a, 2b, 2c . . . in the site, by which access from the Internet to the content server 2a, 2b, 2c . . . is enabled and two-way data communication among equipment is enabled; a false access detection system (IDS) 4 that is the false access detecting means for detecting the presence of false access on receiving the output of copied data of access data, which is filtered by a firewall function built in the L4 switch 3; and the access analysis system 5 that is the false access cutoff means for cutting off the communication of false access by sending out a reset packet based on the detection notification of false access by the false access detection system (IDS).

Note that, in site A provided with the main server 2a as described above, the virtual private network (VPN) system 6 for building a virtual private network with the virtual private network (VPN) system 6, which is connected with the client server 1 via the Internet, is connected with the L4 switch 3.

As the virtual private network (VPN) system 6, a widely-known virtual private network (VPN) system 6 may be used as long as it has a function to encrypt a private (local) IP address packet on a local area network, transmit the encrypted packet after a global IP header, which consists of the global IP address of the other party that is a transmission destination and the global IP address of itself that is a transmission source, is added thereto, remove and decrypt the global IP header by a receiving party to reconstruct the private (local) IP address packet, and send the restored private (local) IP address packet onto the local area network.

As described, connecting the client server 1 and the site using the VPN system 6 to distribute the content registered with the client server 1 to the content servers 2a, 2b, 2c . . . is preferable because the content can be distributed to the internet terminals 8 of the end users without the need of releasing the domain name of the client server 1 to the public, by which the attacks to the client server is avoided as much as possible, and the attacks to the client server becomes difficult due to the use of the VPN system 6. However, the present invention is not limited to this, and a constitution may be one where the domain name of the client server 1 is released to the public, the client server transmits the content data such as text and the content servers 2a, 2b, 2c . . . transmit the content data such as images when access is made from the internet terminals 8, for example.

Further, the content providing service company is provided with a DNS server 7 that stores URLs, which make the content accessible, the IP address of the content server 2a, 2b, 2c . . . of each site, load table where the information of distribution (communication) load to each site is collected and registered, and the like.

The processing content performed by the DNS server of this embodiment is described by using the flowchart shown in FIG. 3. The DNS server 7 detects the presence of inquiry for the domain name by the internet terminals 8 of the end users (Sa1), proceeds to Sa2 when it detects an inquiry for the domain name, proceeds to Sa5 in the case of no such detection and executes detection of the presence of load status notification from the layer 4 (L4) switch 3 of each site, returns to Sa1 when it does not detect the load notification, and detection wait of the inquiry for the domain name or the load status notification from the layer 4 (L4) switch 3 of each site is executed.

Herein, when the load status notification is detected at Sa5, the server proceeds to Sa6 and updates/registers the load status of a site specified by a received load status notification to a load status based on the received load status notification on the load table with which the load status of each site is registered, and then returns to start.

Furthermore, when the server detects the inquiry for the domain name from the internet terminals 8 at Sa1, it proceeds to Sa2 and refers to the load table which is updated to the latest load status, specifies the IP address of the content server 2a, 2b, 2c . . . installed in a site having least load (Sa3), and replies to the internet terminal 8 that made inquiry for the IP address of the specified content server 2a, 2b, 2c . . . (Sa4). Consequently, the DNS server substantially equalizes the load to each site with respect to the inquiry for the domain name from the internet terminals 8 of the end users.

As described, making the DNS server 7 bear the access dispersing means is desirable since the DNS server constantly monitors the access and the access dispersing means is preferably built. However, the present invention is not limited to this, and the access dispersing means for assigning the access so as to equalize it to each site may be provided in addition to the DNS server 7. A widely known server computer may be used as the DNS server 7.

Next, as the content servers 2a, 2b, 2c . . . used in the content distribution system of this embodiment, the widely known server computer may be used as long as a web application having a function to distribute the registered content data and an operation system program (OS) capable of operating the web application are installed.

Next, in the layer 4 (L4) switch 3 used in the content distribution system of this embodiment, an external connection section, to which an external communication device (not shown) for communicating with the Internet is connected, and an internal connection section, to which various kinds of equipment in the site such as the content server 2a, 2b, 2c . . . , the false access detection system (IDS) 4, and the access analysis system 5 are connected, are provided on its front face. And also communication path switching circuits (switches) are provided between the external communication section and the internal communication section, where switching by the IP header of the layer 4 of communication protocol is executed to enable the communication among equipment connected to each connection section and data sending/receiving between the both communication path switching circuits are enabled.

A filter processing section to perform filtering not to allow access from predetermined IP addresses, which are previously registered with a configuration file, is provided between the both communication path switching circuits (switches), as shown in FIG. 2, where the filter processing section adds the firewall function to the layer 4 (L4) switch 3 and the data of the configuration file is updated based on an update instruction output from the access analysis system 5.

Further, transit data (access data) from outside having passed the filter processing section is copied by a copy processing section and a mirror packet is created, the created mirror packet is output from a mirror port provided on the front face of the device to the false access detection system (IDS) 4, which is connected with the mirror port, and original transit data (access data) is output to the content servers 2a, 2b, 2c . . . (refer to FIG. 7).

Note that, in the layer 4 (L4) switch 3 used in this embodiment, the communication path switching circuit provided corresponding to the external connection section is provided with a traffic monitor processing section for monitoring communication load (traffic) in the communication path switching circuit associated with the access from outside and the distribution of content data, in which a traffic status monitored by the traffic monitor processing section is transmitted via the Internet to a previously registered global IP address of the DNS server 7 along with a site ID, by which a site can be specified, the DNS server 7 receives the traffic status to update and register it to the load table, and thus the DNS server 7 can sequentially grasp the load status of each site.

Next, the false access detection system (IDS) 4 used in the content distribution system of this embodiment is described. As the false access detection system (IDS) 4 used in this embodiment, a server computer capable of executing relatively high-speed processing, in which a false access detection program is installed, is used.

In the processing content of the false access detection system (IDS) 4 of this embodiment, the system reassembles the mirror packet output from the mirror port of the layer 4 (L4) switch 3 (Sb1), executes comparison/checking to the reassembled communication data row with the false access patterns previously registered with the false access pattern file (Sb2), and returns to Sb1 when the comparison does not match the false access patterns to execute Sb2 and Sb3 again, as shown in FIG. 4.

Further, when the comparison matches the false access patterns in the judgment at Sb3, the system proceeds to Sb4 and outputs the false access detection notification including the IP address of those who made a false access to the access analysis system 5.

As described, single computer forms the false access detection system (IDS) 4 in this embodiment in order to execute in high-speed and accurately the detection processing of false access by the false access patterns inherent in enormous communication data. However, the present invention is not limited to this, and the high-speed computer may be integrated with the layer 4 (L4) switch 3 or may be integrated with the access analysis system 5 (described later).

As the access analysis system 5 that receives the false access detection notification output from the false access detection system (IDS) 4, a widely known personal computer relatively superior in processing power, in which an application program for access analysis is installed, is used in this embodiment.

The processing content that the access analysis system 5 of this embodiment performs is as shown in FIG. 6. First, it detects the false access detection notification output from the false access detection system (IDS) 4 (Sd1), proceeds to Sd7 in the case of no detection notification and detects the presence of information regarding false access detection from the access analysis system 5 of another site, and returns to Sd1 in the case of no information notification regarding the false access detection.

The system proceeds to Sd2 when detection notification exists at Sd1, specifies a corresponding session based on the IP address information of those who made false access included in the detection notification, and updates and registers the notified IP address and the degree of risk of those who made false access with the table.

Following the registration, the system outputs the update instruction of a filter configuration file of the layer 4 (L4) switch 3 based on the IP address information of those who made false access, and registers the IP address of those who made false access (Sd3).

Subsequently, the system proceeds to Sd4, judges whether the degree of risk level of those who made false access, where the table has been updated as described above, is a predetermined value or more. The system proceeds to Sd6 when the level does not reach the predetermined degree of risk, or proceeds to Sd5 when the degree of risk level of those who made false access is the predetermined value or more. Then, the system sends out an action corresponding to the degree of risk to a session, which is a reset packet to the session if it is the maximum degree of risk, for example, to specify an action for turning off the session and to execute the action, and the system proceeds to Sd6.

At Sd6, information regarding the detection of false access such as the access pattern information of false access and the IP address information of those who made false access, for example, is notified to the access analysis system 5 of another site.

The access analysis system of another site detects transmitted information regarding the detection of false access at Sd7, and the system proceeds to Sd8 based on the detection.

At Sd8, the system temporarily stores the notified information and specifies the false access pattern included in the notified information, and outputs the update instruction to the false access detection system (IDS) 4 so as to register the false access pattern with the false access pattern file (Sd9). Furthermore, the system proceeds to Sd10, and specifies the IP address of the false access included in the notified information, and outputs the update instruction to the layer 4 (L4) switch 3 so as to register the IP address with the filter configuration file (Sd9). With this procedure, when false access is detected in any site, the information of the false access is reflected on the other sites, so that the other sites efficiently detect and deal with access from the same one who made false access.

As described, notifying the information of false access to the other sites allows the layer 4 (L4) switches 3 and the false access detection systems (IDS) 4 of the other sites to quickly deal with the attacks by the false access, which is preferable because the defensive capability of the entire system can be improved, but the present invention is not limited to this.

Regarding the update instruction, which is output to the false access detection system (IDS) 4 based on the information notification of false access from the access analysis system 5 of another site, when the IDS 4 detects the presence of the update instruction (Sc1), it temporarily stores the received update instruction data and registers the false access pattern included in the stored update instruction data with the false access pattern file to update the file, as shown in the flowchart shown in FIG. 5.

In the following, the operation in the content distribution system of this embodiment is described. Firstly in the internet terminals 8 of the end users, the DNS server 7 replies to an end user, who has inquired about the IP address of a content server of site having the least load, for the inquiry for the URLs given to the content data and released to the public based on the load table updated according to the load notification from the layer 4 (L4) switch 3 of each site, as shown in the flowchart of FIG. 3.

Based on the reply of the IP address, the internet terminal 8 of the end user transmits a content request to the content server 2a, 2b, 2c . . . of the replied IP address. The content request is passed and conveyed to the content server 2a, 2b, 2c . . . if the IP address of the internet terminal 8, which is a transmission source, is not registered with the configuration file by the layer 4 (L4) switch 3.

Based on the reception of the content request, the content server 2a, 2b, 2c . . . transmits the required content data to the IP address of the transmission source, and thus the content is displayed or reproduced on the internet terminal 8.

Here, in the case where those who made false access executes the DDoS attacks, for example, the attacks by those who made false access are dispersed to each site by the DNS server 7 and they do not concentrate on one site. Thus, the dispersed attack load allows the false access detection system (IDS) 4 to accurately detect the false access, and the content servers 2a, 2b, 2c . . . and the client server 1 can be defended against the attacks by those who made false access.

With the above-described embodiment, the monitoring DNS server, which is the access dispersing means, disperses the content distribution requests (access) from the computers 8 of access users, which are the internet terminals, to each content server 2a, 2b, 2c . . . such that the load is substantially equalized, and access load to each site is sufficiently reduced. Therefore, even if the DDoS attack are conducted, the false access detection system (IDS) 4 which is the false access detecting means surely detects false access and surely cuts off the false access, so that the content servers 2a, 2b, 2c . . . and the client server 1 can be defended against the false access.

The embodiments of the present invention have been described by the examples by referring to the drawings, but the present invention is not limited to the examples and it goes without saying that modifications and additions without departing from the scope of the present invention are included in the present invention.

For example, although the internet terminal 8 is a personal computer in the examples, the present invention is not limited to this, and it is not needless to say that the internet terminal 8 may be a cell phone, a PDA, or the like as long as a browser application capable of displaying or reproducing the distributed content is installed therein.

Further, although only site A provided with the main server 2a and the client server 1 are connected via VPN in the examples, the present invention is not limited to this, and the VPN system 6 may be installed in each site to connect each site via VPN or the DNS server 7 may be connected via VPN.

### Description of Reference Numerals

1: Client server

2a: Content server (main server)

2b: Content server (cache server)

2c: Content server (cache server)

3: Layer 4 (L4) switch

4: False access detection system (IDS)

5: Access analysis system

6: Virtual private network (VPN) system

7: DNS server

8: Internet terminal

1. A content server defending system for defending content servers that distribute content registered through the Internet to internet terminals, which are capable of connecting with the Internet, against false access, said system comprising:
auxiliary servers with which copied content data copied from at least a part of distribution content data registered with said content servers is registered, and which are capable of distributing the copied content data to said internet terminals;
an access dispenser for assigning requests from said internet terminals to distribute the content to each of said servers so as to substantially equalize the distribution load on each server;
a false access detector for detecting false access to each server; and
a false access cutoff for cutting off the communication of false access when the false access detector detects the false access.

2. The content server defending system according to claim 1, wherein a false access detector and a false access cutoff are provided corresponding to each server, the false access detector or the false access cutoff of each server notifies another false access detector or false access cutoff of information regarding the false access based on the detection of false access by said false access detector.

3. The content server defending system according to claim 1, wherein said access dispenser combines a DNS server that transforms a domain name on the Internet into an IF address of each server on the Internet.

4. The content server defending system according to claim 1, wherein domain names, which are released to the public and different from those of the content servers, are given to said auxiliary servers, and the IP addresses of the content servers are not released to the public.
